(19) United States
(12) Patent Application Publication
(10) Pub. No.: US 2024/0403820 A1
(43) Pub. Date: Dec. 5, 2024

(54) MONTE-CARLO TREE SEARCH-BASED METAHEURISTIC FOR FASTER OPTIMAL FLEET ALLOCATION

(71) Applicant: Ford Global Technologies, LLC, Dearborn, MI (US)

(72) Inventors: Mithun Goutham, Columbus, OH (US); Stephanie Stockar, Columbus, OH (US); Meghna Menon; Sarah Garrow, Coral Gables, FL (US); Tren Martinus Johannes Theodor Baltussen, Nijmegen (NL)

(73) Assignee: Ford Global Technologies, LLC, Dearborn, MI (US)

(21) Appl. No.: 18/328,665

(22) Filed: Jun. 2, 2023

(51) Int. Cl. G06Q 10/087

(52) U.S. Cl. CPC G06Q 10/087

(57) ABSTRACT

A method of managing a fleet of robots for delivery of materials in a facility is provided. The method includes: determining a sequence of waypoints by a Branch and Bound (B&B) method; determining a path through the sequence of waypoints by a dual graph method; and determining a fleet composition and distribution of tasks among the robots by the B&B method and a Monte Carlo Tree Search (MCTS) method.

### FIELD

The present disclosure relates to systems and methods for managing delivery of materials in an automated facility, and more particularly to systems and methods for managing delivery of materials by a fleet of robots in an automated facility.

### BACKGROUND

The statements in this section merely provide background information related to the present disclosure and may not constitute prior art.

Autonomous mobile robots (AMR) have been used in a production line to deliver materials to different task stations. For a defined set of material handling requirements, the fleet of robots pick up and drop off materials among different locations in a factory or a warehouse. The material flow throughput of a facility depends on numerous decisions to be made, which involve purchasing the robots that form the fleet, the distribution of tasks among these robots, the sequence with which each robot must visit the locations associated with its assigned tasks, and the path to be taken by the robot. These decisions are closely inter-linked and the purchase decisions made about the fleet composition affect the ability to distribute tasks among the robots, their visit sequences and their paths.

The selection of such a fleet of AMRs is a strategic problem and involves considerable capital investment. When considering all of the constraints of factory or warehouse operation, the problem of selecting the optimal fleet composition that minimizes costs is exceedingly large. Finding the global optimal, or near optimal solution, of this large-scale optimization problem requires great computational resources.

### SUMMARY

To this end, the present disclosure presents a method for finding the globally optimal fleet composition within a significantly reduced computation time.

This section provides a general summary of the disclosure and is not a comprehensive disclosure of its full scope or all of its features.

A method of managing a fleet of robots for delivery of materials in a facility is provided. The method includes: determining a sequence of waypoints by a Branch and Bound (B&B) method; determining a path through the sequence of waypoints by a dual graph method; and determining a fleet composition and distribution of tasks among the robots by integrating the B&B method and a Monte Carlo Tree Search (MCTS) method.

In other features, the method further includes determining a candidate fleet composition by using the MCTS method, using the least operational cost to update an upper bound in the B&B method, partitioning a search space of the B&B algorithm by a plurality of processors, and determining the distribution of tasks by a random rollout, backpropagating the operational cost through a tree of the MCTS algorithm. The candidate fleet composition is the most efficient fleet composition that has the least operational cost. The search space is partitioned based on the number of robots. The fleet composition includes a number of robots and types of robots in the fleet. The fleet of robots include a plurality of autonomous mobile robots (AMRs). The method further includes: using the MCTS algorithm to provide bound estimates for a search space using the B&B algorithm, and continuously updating an upper bound of a search by the B&B algorithm by a search result of the MCTS algorithm. Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic diagram of a fleet management system in accordance with the teachings of the present disclosure;

FIG. 2 is a schematic diagram of a layout of an automated facility;

FIG. 3 is a schematic diagram of two possible paths for a robot tasked with moving some item from one waypoint to another;

FIG. 4 is a dual graph representation of the paths of FIG. 3;

FIG. 5 is a schematic diagram of an optimal path for a robot navigating through ten waypoints when two consecutive waypoints are considered at a time for path planning;

FIG. 6 is a schematic diagram of an optimal path for a robot navigating through ten waypoints when an entire sequence of waypoints or staggered three waypoints are considered at a time for path planning;

FIG. 7 is a schematic diagram of four waypoints with constraints on the sequence of the waypoints, wherein points (a) and (c) are pickup locations, and points (b) and (d) are corresponding drop-off locations;

FIG. 8 is a tree diagram illustrating all possible paths for a robot navigating through the four waypoints of FIG. 7, based on a Branch and Bound algorithm;

FIG. 9 is a tree diagram illustrating all possible assignment of tasks to the plurality of robots based on the Branch and Bound algorithm with a parallel implementation of the Branch and Bound algorithm by a plurality of processors;

FIG. 10 is a diagram showing a multi-stage approach to determining the fleet size, the fleet composition, the task assignment, node sequencing and path planning by integrating a Branch and Bound algorithm and a Monte Carlo Tree Search algorithm;

FIG. 11 is a diagram showing an integrated B&B algorithm and MCTS Metaheuristic in fleet optimization, wherein the B&B is guided by the MCT metaheuristic;

FIG. 12 is a method of managing a fleet of robots navigating through waypoints in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

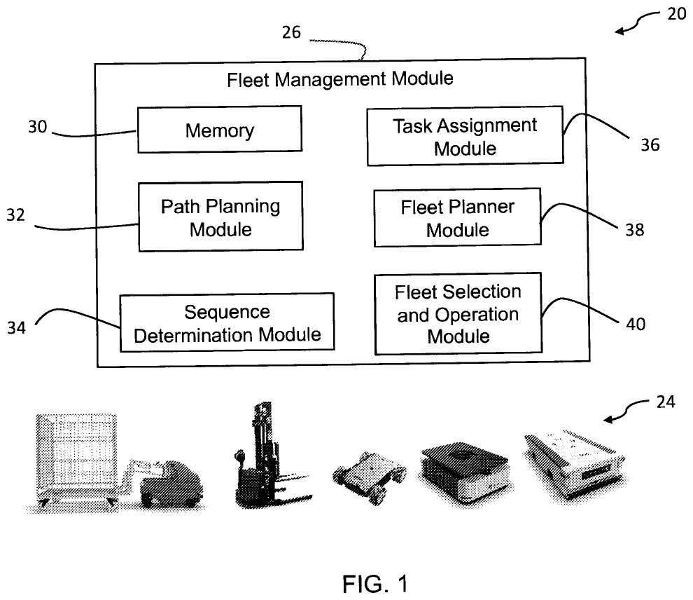

Referring to FIG. 1, a fleet management system 20 for managing delivery of materials in a facility in accordance with the teachings of the present disclosure includes a fleet of robots 24 configured to autonomously deliver materials from and to various locations of the facility and a fleet management module 26 configured to manage and control delivery of materials by the fleet of robots 24 in the facility.

The fleet management module 26 includes a memory 30, a path planning module 32, a sequence determination module 34, a task assignment module 36, a fleet planner module 38, and a fleet selection and operation module 40. The memory 40 is configured to store information of a layout of the facility, constraints on movement of the robots, and the types of the robots in the fleet of robots 24. The movement constraints refer to factors that affect the planning of the movement of the robots in the facility, such as the time windows of each pickup or drop-off locations, the state of charge (SOC) of the batteries of the robots, and a required order between the pickup and drop-off locations. The fleet of robots 24 includes autonomous mobile robots (AMR) that can travel autonomously to various locations in the facility according to a prescribed path. The robots may be any available models, and may of the same type, different types, or a combination of any available models. For example, the fleet of robots may include two of one type and four of another type. The robots shown in FIG. 1 are only for illustrative purposes and the solution proposed in this application is not limited to the robots shown in FIG. 1. Each robot may be configured to pick up multiple items from multiple pickup locations and to drop off multiple items at multiple drop-off locations.

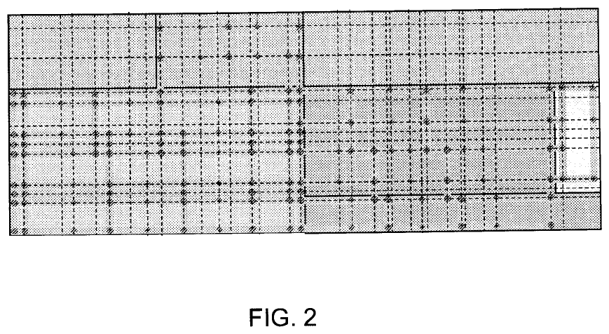

Referring to FIG. 2, the facility may be a factory 22 in which products, such as vehicles, are manufactured. Shaded regions represent various features of the factory layout that may include inventory holding locations, specialized work stations and robot charging or idling bays. The robots are responsible for the movement of material between the different regions. They are permitted to travel along the pathways that connect the different shaded regions. The pathways available for the fleet of robots 24 may be represented by a graph of nodes that discretizes the pathways of the fleet of robots 24 into a plurality of nodes. Nodes represent physical locations of the intersections of pathways and material handling locations of interest, namely the pickup and drop-off locations for the items to be transported by the fleet of robots 24.

The path planning module 32 is configured to determine the total path costs for all possible paths by using, for example, the dual graph method in order to identify the path of least cost to be taken by a robot that must navigate through a defined sequence of waypoints. Other methods can be used without departing from the scope of the present disclosure. Waypoints are material-handling nodes and are restricted to the pickup and drop-off locations where the fleet of robots 24 pick up and drop off items, respectively. The total path cost includes a traversal cost and a pivoting cost (or a turn cost, a vertex cost). Traversal costs refer to the costs associated with translational movement between consecutive waypoints. The pivoting costs refer to the costs associated with turning of the robots to change a travel direction of the robots. Other costs can be used without departing from the scope of the present disclosure.

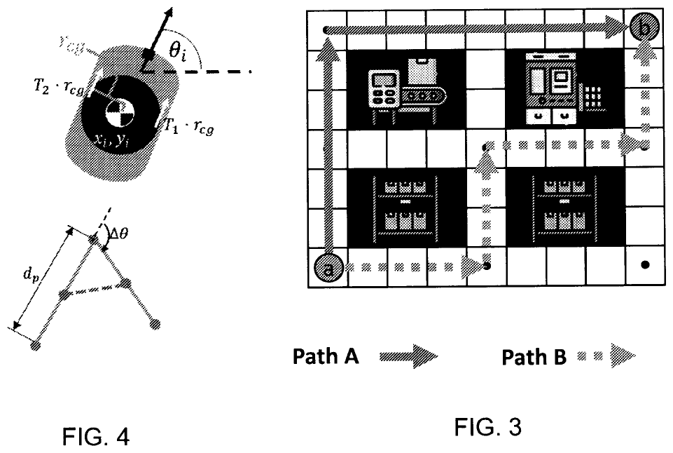

Referring to FIG. 3, the traversal cost and the pivoting cost associated with a robot navigating through consecutive waypoints is now explained. In the illustrative example of FIG. 3, path A and path B are two possible paths for a robot travelling from point (a) to point (b). The robot is oriented to head north in the travel direction of path A. The travel distance for path A or path B is the same and thus the traversal costs for path A and path B are the same. However, the robot needs to make one 90° turn for path A and four 90° turns for path B to travel from point (a) to point (b). More power is used and more time is spent in changing direction of the robot for path B. Therefore, path B has a higher pivoting cost than path A.

The material flow throughput of a facility can be enhanced by reducing the time spent on travelling, turning, waiting and charging by the robot when navigating through the assigned sequence of waypoints. Therefore, an optimal path is one that has least overall path cost including the traversal cost and the pivoting cost.

Referring to FIG. 4, to consider the pivoting cost more efficiently, a dual graph method is used. A dual graph is a method in space syntax that considers edges as nodes and nodes as edges. In road networks, large avenues made of several segments become signal nodes, while intersections with other avenues or streets become links (edges). The edges are weighted by the total cost of traversal and orientation changes. This method is useful for revealing hierarchical structures in a planar network. Based on a planar network such as urban streets (A), space syntax proposes to consider line segments differently from traditional graph theory, where links (edges) are streets and intersections are nodes (vertices). The optimal path with least overall cost can be obtained by numerous polynomial time algorithms such as the Dijkstra's algorithm, or the A* algorithm if an admissible heuristic exists.

In the illustrative example that has only two waypoints in FIG. 3, path A and path B each have a travel distance of 140 m. Path A requires one 90° turn, whereas path B requires four 90° turns. The power consumed is 214 kj for path A and 244 kj for path B, which is 14% more than path A. The time required is 87.2 seconds for path A, and 89.6 seconds for path B, which is 3% more than path A. Therefore, path B has higher total path cost than path A. These values are only for illustrative purposes and are not used to limit the scope of the present disclosure.

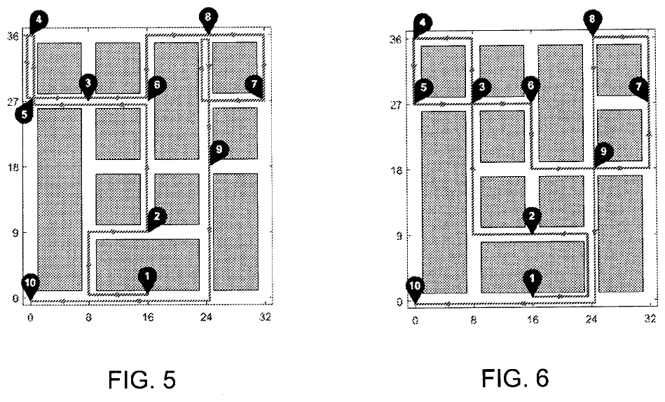

Referring to FIGS. 5 and 6, for a facility that has more than two waypoints, such as ten waypoints in the illustrative example, the optimal path (i.e., the path with the least total path costs) based on the dual graph method may depend on the number of waypoints being considered at a time. FIG. 5 shows an optimal path when only two consecutive waypoints are considered at a time. FIG. 6 shows an optimal path when all of the ten waypoints are considered at a time. Based on the dual graph analysis, the path in FIG. 6 can achieve 10% reduction in total path costs. It is understood that the value is only for illustrative purpose and is not used to limit the scope of the present disclosure. Therefore, to find an optimal path, the sequence of all the ten waypoints should be considered at a time.

For a multi-load mission, assuming that the path between consecutive waypoints is independent of other waypoints generates unnecessary constraints in robot orientation. This yields sub-optimal solutions, because the optimal path between waypoints is dependent on the robot orientation at each waypoint, which is unconstrained in the true problem.

The dual graph method can be used to find an optimal path for a multi-load robot through a sequence of spatial waypoints. The waypoint sequence representation is capable of accounting for time, energy, or any relevant cost associated with the robot moving through the environment. This includes vertex costs such as turn costs, wait time at intersections or when merging into higher traffic pathways. Depending on the environment waypoint sequence and cost function, a substantial reduction in path cost can be realized when compared with the approach of using only two waypoints at a time.

However, when the number of nodes in the waypoint sequence representation is huge, it may pose a computational problem if the sequence of all of the waypoints is considered at a time. A case study has shown that a staggered three waypoints method can be used instead. The staggered three waypoints method is an approximate method that can obtain near optimal paths by breaking the waypoint sequence problem into sub-problems that contain three consecutive waypoints. It has been determined that considering the waypoint sequence instead of just consecutive pairs of waypoints results in fewer and smaller turns. This is because the two waypoints method does not have the look-ahead capability of the staggered three waypoints or global approaches. The staggered three waypoints method scales much better than the global method. A case study has shown that path planning using three consecutive waypoints at a time is computationally more efficient and there is no optimality gap with the solution found considering all waypoints at a time.

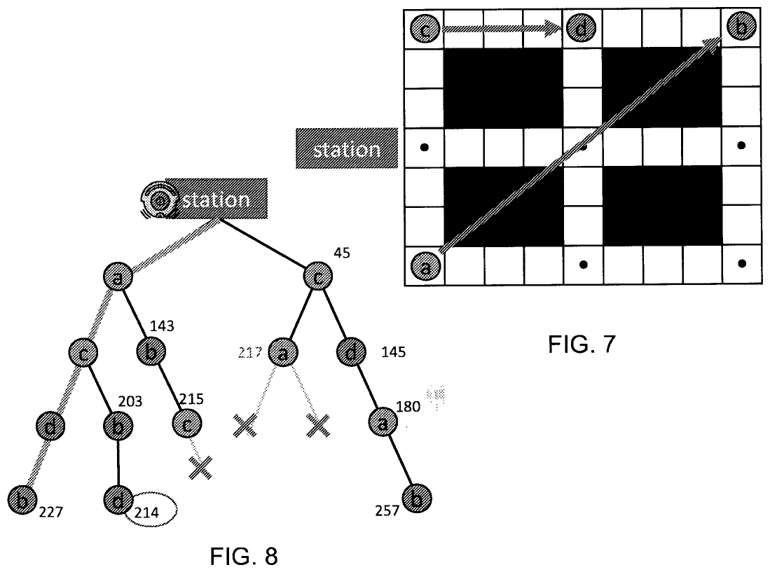

Referring to FIG. 7, after the total path costs of all possible paths are determined by the path planning module 32, this information is sent to the sequence determination module 34, which is configured to determine a sequence of the waypoints, taking movement constraints into consideration. In the illustrative example of FIG. 7, the path for a robot may include pickup points (a), (c) where materials are to be picked-up and drop-off points (b), (d) where the materials are to be dropped off. One or more of the pickup points must be visited before the fleet 24 of robots travels to the corresponding one or more of the drop-off points. Therefore, the sequence of some of the pickup locations and the drop-off locations pose a constraint on the path planning.

The sequence determination module 34 is configured to determine a path for a robot, taking these constraints into consideration, by using a Branch and Bound (B&B) algorithm. B&B is a method for solving optimization problems by breaking them down into smaller sub-problems and using a bounding function to eliminate sub-problems that cannot contain the optimal solution. B&B algorithms systematically partition the solution search space into subsets that are arranged in a tree structure. The root of the tree is the original problem and the leaves of the tree are individual candidate solutions to the original problem. Between the root and the leaves are intermediate nodes that represent subproblems obtained by recursively partitioning the original problem by a process called branching. The order according to which these subproblems are examined is determined by a best-first selection criteria that first explores the subproblem with the least cost, i.e., exploitation.

For minimization problems, the upper bound is the incumbent solution defined as the most efficient (i.e., the least cost) candidate solution to the original problem found at the leaf node. The upper bound is continuously updated as the tree is explored, and is used to prune sub-optimal branches without recursively evaluating their solutions up to the leaf node. Thus, as the algorithm searches from the root to the leaves, branching is conducted only if the cost at the node is lower than the incumbent solution, and branching can potentially find a better solution than the incumbent solution. Following this process, the B&B algorithm recursively decomposes the original problem until further branching is futile when the solution cannot be improved, or until the original problem has been solved when every feasible branch has been evaluated.

Referring to FIG. 8 in conjunction with FIG. 7, as shown in the illustrative example, points (a) and (c) are the pickup locations and points (b) and (d) are drop-off locations and thus the robots must first travel to point (a) or point (c) to pick up items before traveling to point (b) or point (d) to drop off the items. Considering this constraint, a plurality of possible sequences are analyzed using the B&B algorithm. The B&B algorithm explores all possible sequences in the form of branches of a tree. For example, six possible sequences are shown. The first possible sequence is (a)->(c)-(d)->(b) having a total path cost of 227. The second possible sequence is (a)->(c)->(b)->(d) having a total path cost of 214. During exploring of the sequence, the upper and lower estimated bounds on the optimal solution are checked. Therefore, during exploring of the third possible sequence (a)->(b)->(c), before the fourth node (d) is explored, the path cost of 215 is checked against the lower estimated bound 214 of the second possible sequence. Since the third possible sequence cannot produce a better solution than the second possible sequence due to the higher total path cost, the third possible sequence is discarded. It is understood that if the initial path (i.e., the first possible sequence) evaluated is chosen well (i.e., with a relatively lower total path cost), more sequence branches can be cut earlier, thereby reducing the number of computations by the B&B algorithm.

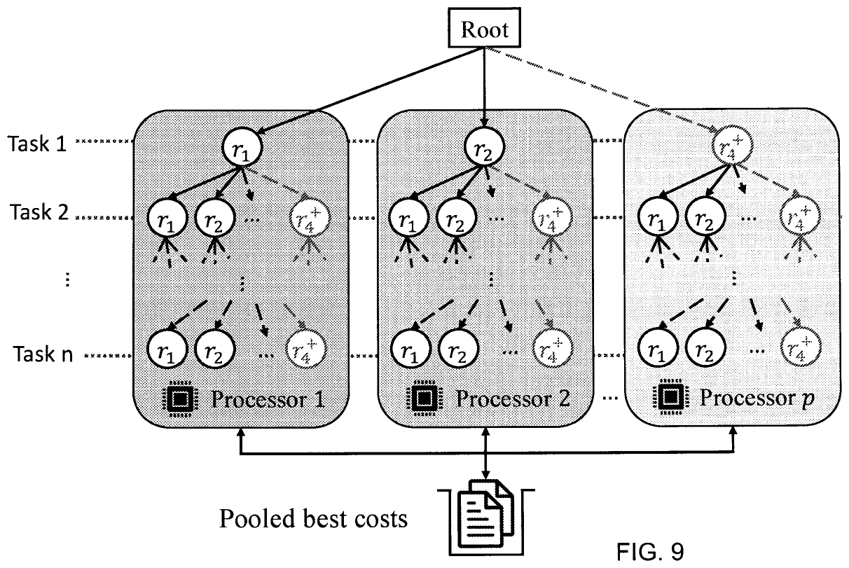

The sequence cost associated with assigning a set of tasks to a robot is relayed to the task assignment module 36 shown in FIG. 9. The task assignment module 36 uses another B&B algorithm to explore the assignment of tasks between the available robots that form the candidate fleet. Since the B&B algorithm scales poorly with increased number of tasks and robots, this can be implemented, for example, in a high-performance computing framework. Each processor is assigned a subset of the overall search-space and as shown in FIG. 9, several subproblems are explored simultaneously.

During each processor's exploration of its search-space, updated incumbent solutions related to the best known task assignment decisions, are instantaneously made available to every processor. This is implemented in an asynchronous information sharing method using a shared work pool as shown in FIG. 9. Further, for each processor, the B&B algorithm is implemented by a recursive function to minimize memory and computational requirements as the tree is explored.

Further, since the computation time of B&B algorithms increases with the number of feasible branches at each node, the candidate fleet is initiated with a smaller candidate fleet than the maximal fleet possible. After evaluating the total cost of this candidate fleet using the parallel processing framework, the number of robots is incrementally raised until further increments do not reduce the total cost or additional robots remain idle. This is shown in FIG. 9 as the added robot rt. For each fleet increment, only B&B subproblems that include at least one of the newly added robots are evaluated. This ensures that computational resources are not wasted since other solutions are guaranteed to have been evaluated already.

While the described algorithm is capable of finding the globally optimal fleet composition after accounting for task assignment decisions, visit sequences and path planning, it is computationally expensive because it proceeds by systematically exploring the entire search space. The task assignment module 36 of FIG. 9 shares the best costs among processors, but these best costs only consider the candidate fleet being considered which limits the search space. To reduce computation time, the fleet planner module 38 is configured to use both B&B algorithm and Monte Carlo Search Tree (MCST). B&B algorithm is used to find an optimal solution, whereas MCTS is used to explore the entire search space which includes all possible fleet compositions and reports its best known costs to the pooled best cost used by the B&B algorithm.

The MCTS is used as metaheuristic methods due to its ability of finding near-optimal solution in a limited time. This is possible because of its ability to balance global and local exploration of the search space. Each iteration of the MCTS involves four steps: selection, expansion, simulation, and backpropagation. However, such approximate methods do not provide guarantees on the optimality of the solution. For this reason, both the B&B algorithm and the MCTS algorithm are executed simultaneously. Considering the objective of finding the globally optimal solution to the fleet composition optimization within a finite computation time, the strength of the MCTS lies in its ability to rapidly explore the search space while also conducting local searches.

The MCTS algorithm is used to guide the exact B&B algorithm to the optimal point. MCTS is most effective as a heuristic at the early stages of the decision problem. Combining the B&B algorithm and the MCTS algorithm in the search can take advantage of the strengths of the B&B algorithm and the MCTS algorithm to provide a more effective and efficient search.

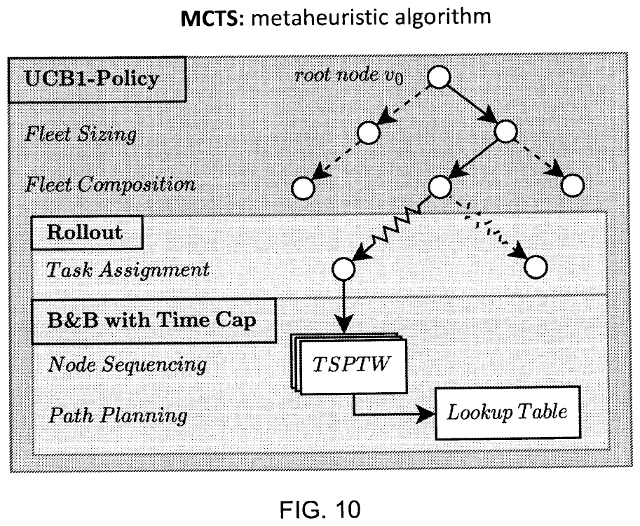

Referring to FIG. 10, at the top-most decision making level, the MCTS algorithm explores the fleet size (i.e., the number of robots in the fleet) and the types of robots that form the fleet composition. The algorithm finds an estimate of the expected total cost associated with a particular fleet size and composition. This estimate serves as a measure for the quality of that set of candidate solutions. Additionally, during this rapid exploration of the solution space, the candidate solution with the best cost is saved and used to prune branches in the B&B algorithm.

For each candidate fleet considered by the MCTS, the expected cost of task assignments is determined by a random rollout. Considering that the number of permutations at the task assignment level is exponential with the number of tasks, it is deemed sufficient to take a random task assignment. In order to prevent any bias toward another fleet size, it is ensured that the full fleet size is utilized, i.e., each AMR in the fleet will have at least one assignment.

For each task assignment obtained in the rollout, the order of visiting locations, or the node sequence is solved using a time-limited B&B algorithm of the sequence determination module 34. Since many of the node-sequencing instances encountered are small problem instances, it is advantageous to use the same B&B algorithm to find the optimal solution for each robot. For larger instances of tasks assigned to robots, the B&B is terminated early using a time cap chosen as appropriate for the computation budget.

Optionally, the path cost between different locations is pre-computed and stored as a lookup table to further reduce computation time. Thus, the cost of a candidate node sequence being considered by module 34 is immediately found using the path planning lookup table as shown in FIG. 10.

The operational cost thus obtained for each task assignment considered is backpropagated through the tree and assigned to the node of the MCTS algorithm associated with its originating fleet composition. In this manner, the fleet size and fleet composition are explored rapidly to obtain estimates of cost for the fleet size and composition.

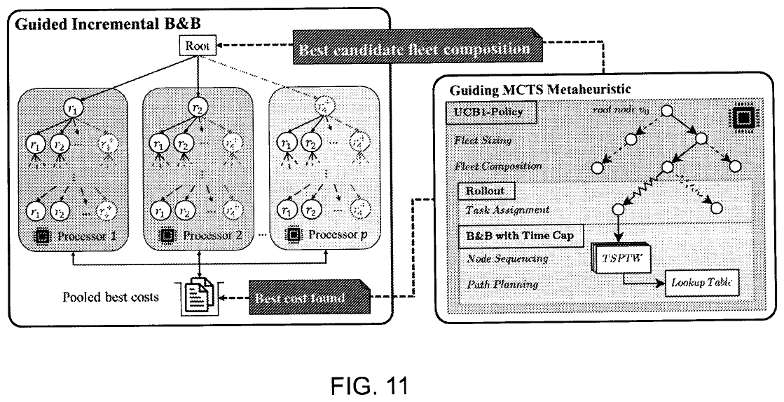

Referring to FIG. 11, during the search of the B&B algorithm for an optimal solution, the described MCTS algorithm is run simultaneously on another plurality of processors and is used as a metaheuristic to look for the optimal solution for the determination of fleet composition while guiding the B&B algorithm to look for an optimal solution. These fleet compositions are used to inform the initial candidate fleet to be considered by the B&B algorithm of FIG. 9, or indicates the next fleet composition to be considered when an increment is to be conducted in the fleet planner module 38.

In addition to this sharing of information, throughout the execution of the MCTS algorithm, the total cost of purchasing the fleet and the operational cost of assigning tasks (by rollout) is tracked. Whenever there is an improvement in the cost, this cost is added to the pooled best costs, as shown in FIG. 11. This helps the B&B algorithm cut branches earlier to provably converge to the globally optimal solution quicker.

A case study has shown that this approach results in a significant reduction in computation time to find the optimal solution. The performance of the proposed method is verified in simulation on different problem sizes. Results shows a significant reduction in computation time, especially for large problems. This solution includes the composition of a possibly heterogeneous fleet and the distribution of tasks within the fleet, based on the defined material handling tasks, the sequence with which the pickup and drop off locations must be visited and the path to be taken.

This hybrid optimization approach combines the speed of metaheuristics with optimality guarantees of exact algorithms by sharing information gleaned from their respective search space explorations. The problem is partitioned to first assign tasks to each robot, with a nested structure that finds the optimal task completion sequence for each AMR. The MCTS and B&B algorithms work simultaneously to find the optimal solution quickly.

For different AMR types available, the fleet is initiated with a candidate, which is chosen based on problem parameters and prior experience so that feasible solutions exist. The chosen fleet is then solved using the described parallel B&B algorithm, and its minimum total cost is found.

On the other hand, the same B&B algorithm can be further used to explore optimal solution for the sequence of waypoints, the path through the sequence of waypoints. For each candidate task assignment being explored, the most efficient (i.e., the least cost) sequence of waypoints is determined by using the B&B algorithm. For each candidate sequence of locations being explored, the most efficient (i.e., the least cost) path through the plant layout is determined by using the dual graph transformation method.

After an optimal fleet composition, an optimal task distribution among the robots, an optimal sequence of waypoints, and an optimal path through the sequence of waypoints are determined, the fleet selection and operation module 40 manages and controls the fleet of robots to move in the automated facility accordingly.

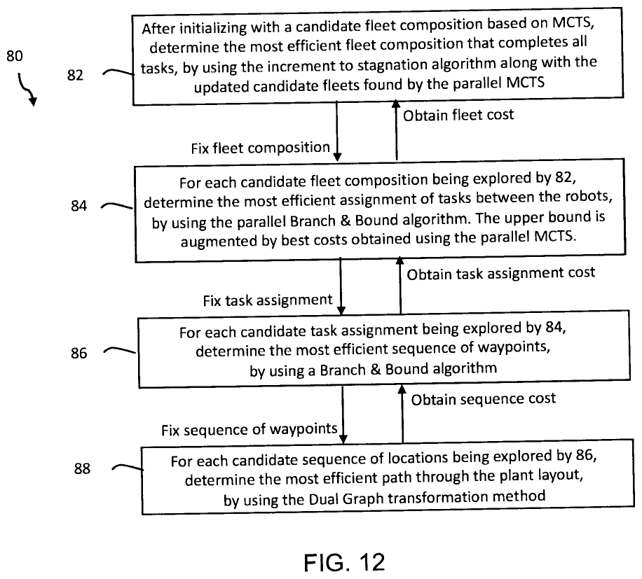

Referring to FIG. 12, a method 80 of managing a fleet of robots through a plurality of waypoints in a facility starts with initializing a candidate fleet composition based on MCTS. After initializing with the candidate fleet composition based on MCTS, the most efficient fleet composition (i.e., the fleet composition with the least cost) that completes the tasks is determined by using the increment to stagnation algorithm along with the updated candidate fleets found by the parallel MCTS in step 82. For each candidate fleet composition being explored in step 82, the most efficient assignment of tasks (i.e., the assignment of tasks with the least cost) between the robots are determined by using a parallel Branch and Bound algorithm in step 84. The upper bound is augmented by best costs obtained using the parallel MCTS. For each candidate task assignment being explored in step 84, the most efficient sequence of waypoints (i.e., the sequence of waypoints with the least cost) is determined by using a Branch and Bound algorithm in step 86. For each candidate sequence of locations being explored in step 86, the most efficient path (i.e., the path with the least cost) through the plant layout is determined by using the dual graph transformation method in step 88. After the most efficient assignment of tasks, the most efficient sequence of waypoints, and the most efficient path are determined in steps 84, 86, and 88, respectively, the sequence cost, the task assignment cost and the fleet cost can be determined.

In the fleet management system and method in accordance with the teachings of the present disclosure, multiple tools are used to manage and control deployment of AMR by: 1. selecting an optimal fleet composition; 2. determining optimal distribution of tasks within the selected fleet; 3. determining an optimal sequence of visiting waypoints once tasks have been assigned; and 4. determining an optimal path through the sequence of waypoints. With the fleet management and method of the present disclosure, an optimal fleet composition is determined and selected to complete all the material handling tasks within the given time windows and with the smallest operation and investment costs. The optimal fleet composition is determined by integrating the B&B algorithm and the MCTS algorithm. MCTS is a reinforcement learning algorithm and is used as a guiding strategy to explore the search space rapidly and reduce computation time for the existing branch- and bound methodology.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of managing a fleet of robots for delivery of materials in a facility, the method comprising:
determining a sequence of waypoints by a Branch and Bound (B&B) method;
determining a path through the sequence of waypoints by a dual graph method; and
determining a fleet composition and distribution of tasks among the robots by integrating the B&B method and a Monte Carlo Tree Search (MCTS) method.

2. The method according to claim 1, further comprising determining a candidate fleet composition by using the MCTS method.

3. The method according to claim 2, wherein the candidate fleet composition is the most efficient fleet composition that has the least operational cost.

4. The method according to claim 3, further comprising using the least operational cost to update an upper bound in the B&B algorithm.

5. The method according to claim 1, further comprising partitioning a search space of the B&B algorithm by a plurality of processors.

6. The method according to claim 5, wherein the search space is partitioned based on the number of robots.

7. The method according to claim 1, wherein the fleet composition includes a number of robots and types of robots in the fleet.

8. The method according to claim 1, wherein the fleet of robots include a plurality of autonomous mobile robots (AMRs).

9. The method according to claim 1, further comprising determining the distribution of task by a random rollout.

10. The method according to claim 1, further comprising backpropagating the operational cost through a tree of the MCTS algorithm.

11. The method according to claim 1, further comprising using the MCTS algorithm to provide bound estimates for a search space using the B&B algorithm.

12. The method according to claim 11, further comprising continuously updating an upper bound of a search by the B&B algorithm by a search result of the MCTS algorithm.
